(19) United States
(12) Patent Application Publication
(10) Pub. No.: US 2026/0278664 A1
(43) Pub. Date: Sep. 17, 2026

(54) MOVEMENT-HISTORY MANAGEMENT DEVICE, MOVEMENT-HISTORY MANAGEMENT METHOD, AND RECORDING MEDIUM

(71) Applicants: NEC Corporation, Tokyo (JP); NEC Platforms, Ltd., Kanagawa (JP)

(72) Inventors: Hiroki SUGEGAYA, Tokyo (JP); Tetsuya MIHIRA, Kanagawa (JP); Shinji OGURI, Kanagawa (JP); Hiroyuki KAWAMOTO, Kanagawa (JP); Susumu ONOHARA, Kanagawa (JP); Asako TOYOTA, Kanagawa (JP)

(73) Assignees: NEC Corporation, Tokyo (JP); NEC Platforms, Ltd., Kanagawa (JP)

(21) Appl. No.: 19/162,478

(22) PCT Filed: Mar. 22, 2023
(86) PCT No.: PCT/JP2023/011282

§ 371 Date: Sep. 5, 2025

(51) Int. Cl. G06Q 30/0601; G06K 19/07

(52) U.S. Cl. CPC G06Q 30/0639; G06K 19/0723

(57) ABSTRACT

A movement-history management device according to the present invention is provided with: a position detection unit for detecting the position of an RFID tag on the basis of a signal received from the RFID tag; a movement detection unit for detecting the movement of the RFID tag on the basis of the history of the position of the RFID tag; and a management unit for associating, as a group of movement histories, the history of the position of the RFID tag for which movement has been detected and the history of the position of another RFID tag for which movement similar to the detected movement of the aforementioned RFID tag has been detected.

### TECHNICAL FIELD

The present disclosure relates to a movement-history management device, a movement-history management method, and a recording medium.

### BACKGROUND ART

There are techniques for identifying products that a customer picked up but did not purchase in a store. For example, one technique includes detecting a customer from a video captured in a store, detecting the customer's route and dwell instances, and identifying products picked up by the customer detected from the video.

PTL 1 describes a technique that estimates products picked up by a customer by identifying products with radio frequency identification (RFID) tags detected to have moved near a movement history of an RFID tag attached to a customer basket for carrying products, or a movement path of an individual detected from a video captured in a store.

### CITATION LIST

### Patent Literature

PTL 1: JP 2018-160033 A

### SUMMARY OF INVENTION

### Technical Problem

In the technique described in PTL 1, it is necessary to detect the movement paths of individuals. The detection of the movement paths of individuals often requires a high processing load and cost.

An example of an object of the present disclosure is to provide a technique for managing a movement history with a simple configuration.

### Solution to Problem

A movement-history management device according to an aspect of the present disclosure includes a position detection means for detecting a position of an RFID tag based on a signal received from the RFID tag, a movement detection means for detecting movement of the RFID tag based on a position history of the RFID tag, and a management means for associating the position history of the RFID tag detected to have moved with a position history of another RFID tag detected to have moved in a manner similar to the RFID tag detected to have moved, as a group of movement histories.

A movement-history management method according to an aspect of the present disclosure includes detecting, by a computer, a position of an RFID tag based on a signal received from the RFID tag, detecting, by a computer, movement of the RFID tag based on a position history of the RFID tag, and associating, by a computer, the position history of the RFID tag detected to have moved with a position history of another RFID tag detected to have moved in a manner similar to the RFID tag detected to have moved, as a group of movement histories.

A movement-history management program according to an aspect of the present disclosure causes a computer to execute detecting a position of an RFID tag based on a signal received from the RFID tag, detecting movement of the RFID tag based on a position history of the RFID tag, and associating the position history of the RFID tag detected to have moved with a position history of another RFID tag detected to have moved in a manner similar to the RFID tag detected to have moved, as a group of movement histories.

The program may be stored in a non-transitory computer-readable recording medium.

### Advantageous Effects of Invention

An example of an effect provided by the present disclosure is that a movement history can be managed with a simple configuration.

### BRIEF DESCRIPTION OF DRAWINGS

FIG. 1 is a diagram illustrating an application example of a movement-history management device of the present disclosure.

FIG. 2 is a block diagram illustrating a functional configuration of a movement-history management device according to a first example embodiment.

FIG. 3 is a diagram illustrating an example of a group of movement histories.

FIG. 4 is a diagram illustrating another example of a group of movement histories.

FIG. 5 is a flowchart illustrating an operation of the movement-history management device according to the first example embodiment.

FIG. 6 is a block diagram illustrating a functional configuration of a movement-history management device according to a second example embodiment.

FIG. 7 is a flowchart illustrating an operation of the movement-history management device according to the second example embodiment.

FIG. 8 is a diagram illustrating another application example of a movement-history management device according to the present disclosure.

FIG. 9 is a diagram illustrating a hardware configuration in which the movement-history management device according to the present disclosure is implemented by a computer device and its peripheral devices.

### EXAMPLE EMBODIMENT

The present disclosure relates to a technique for managing the position histories of RFID tags attached to products sold in a store. A movement-history management device, a movement-history management method, and a program according to the present disclosure associate the position histories of RFID tags that move in a similar manner. The RFID tags attached to products are used for management of the products and the like. For example, the RFID tags attached to products are included in the price label tags used for the payment settlement of the products. In addition, the RFID tags attached to products may be used for management of their positions and the like. The RFID tags attached to products each includes information for identifying the corresponding product.

Movements in a similar manner will be described later.

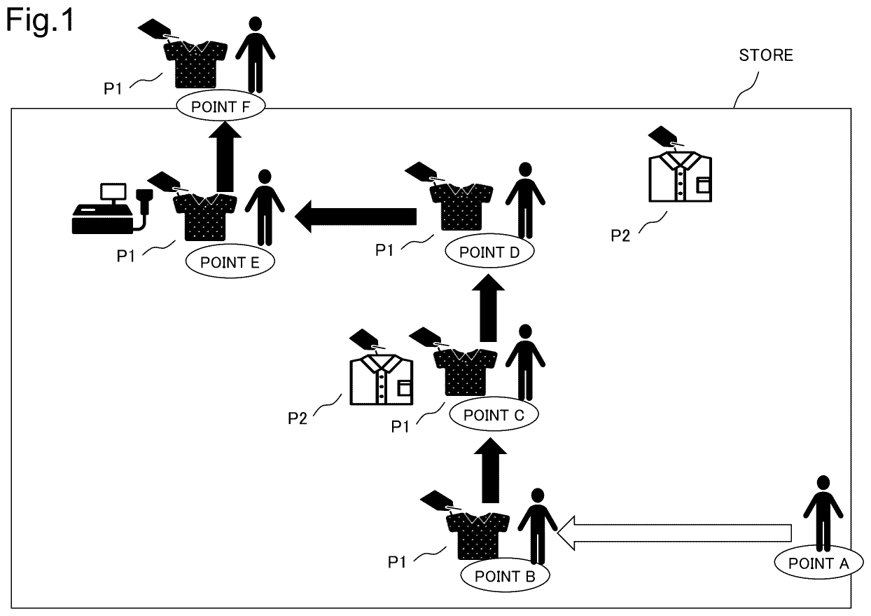

FIG. 1 is a diagram illustrating an application example of a movement-history management device of the present disclosure. An example of behavior of a customer illustrated in FIG. 1 and an example of operation of the movement-history management device will be described.

At a point A in FIG. 1, the customer enters the store. After entering the store, the customer moves therein. The case where the customer is holding an article to which an RFID tag is attached will be described later in another application example.

At a point B in FIG. 1, the customer picks up a product P1 the customer for purchase. In FIG. 1, the customer further moves in the store while carrying the product P1 the customer intends to purchase. At this time, as the customer carries the product P1, the RFID tag of the product P1 moves. Therefore, the movement-history management device detects the movement of the RFID tag of the product P1.

At a point C in FIG. 1, the customer picks up a product P2 for purchase and moves in the store while carrying the products P1 and P2. At this time, in a case where the customer carries the products P1 and P2, the RFID tags of the products P1 and P2 move. The movement-history management device detects the movement of the RFID tag of the product P2 in addition to the movement of the RFID tag of the product P1. The movements of the RFID tags of the products P1 and P2 caused by the customer carrying the products P1 and P2 are similar movements. The movement-history management device associates the position history of the RFID tag of the product P1 with the position history of the RFID tag of the product P2 moving in a similar manner.

At a point D in FIG. 1, the customer puts down the product P2 the customer intended to purchase and moves in the store carrying the product P1. Since the customer puts down the product P2 and carries only the product P1, the product P2 is placed at the point D. That is, the RFID tag of the product P2 no longer moves in a manner similar to the RFID tag of the product P1. Therefore, the movement-history management device detects that the RFID tag of the product P2 has stopped moving in a manner similar to the RFID tag of the product P1. In response to the detection that the two no longer move in a similar manner, the movement-history management device may disassociate the position history of the RFID tag of the product P1 and the position history of the RFID tag of the product P2 from the time they were detected to have stopped moving in a similar manner.

At a point E in FIG. 1, the customer makes a payment for the product P1. In a case where the RFID tag attached to the product P1 is read to pay for the product P1, the movement-history management device may detect that the payment for the product P1 has been made based on the data read from the RFID tag in the payment device. The movement-history management device may end the management of the position history of the RFID tag of the product P1 in response to the detection that the payment for the product P1 has been made. The end of the management will be described later.

At a point F in FIG. 1, the customer leaves the store with the product P1 already paid for. At this time, the position of the RFID tag of the product P1 is no longer detected in the store. Therefore, the movement-history management device may end the management of the position history of the RFID tag of the product P1 in response to the position of the RFID tag of the product P1 not being detected in the store.

As in the example described above, according to the movements of products caused by the customer, the movement-history management device detects the positions of the RFID tags attached to the products, detects the movements of the RFID tags attached to the products based on the position histories of the RFID tags, and associates the position histories of RFID tags that move in a similar manner. The movement-history management device according to the present disclosure can thus manage the movement history with a simple configuration.

Next, each example embodiment of the present disclosure will be described in detail with reference to the drawings.

### First Example Embodiment

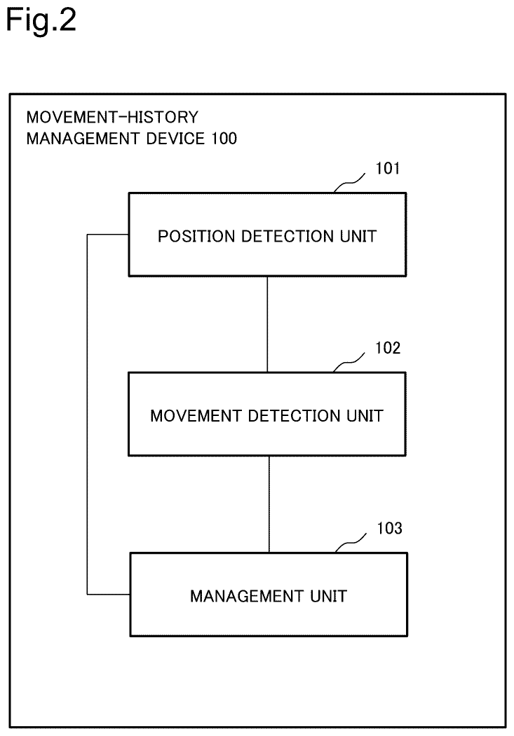

FIG. 2 is a block diagram illustrating a configuration of a movement-history management device 100 in a first example embodiment. Referring to FIG. 2, the movement-history management device 100 includes a position detection unit 101, a movement detection unit 102, and a management unit 103.

Next, the configuration of the movement-history management device 100 according to the first example embodiment will be described in detail.

In FIG. 2, the position detection unit 101 is an example of a position detection means for detecting the position of an RFID tag based on a signal received from the RFID tag. For example, the position detection unit 101 acquires, from an antenna that receives the signal from the RFID tag, or an edge terminal device that collects information from a plurality of antennas, the strength of the signal received from the RFID tag and information for identifying the antenna that has received that signal. A plurality of antennas for receiving signals from RFID tags may be installed in the store so that they cover a desired region in which the positions of the RFID tags are detected. The position detection unit 101 detects the position of the RFID tag in the store based on the acquired signal strength and the position of the antenna determined from the information for identifying the antenna that has received the signal.

Alternatively, an antenna that receives the signal from the RFID tag, or an edge terminal device that collects information from a plurality of antennas may detect the position of the RFID tag in the store based on the strength of the signal received from the RFID tag and information for identifying the antenna that has received that signal, and the position detection unit 101 may acquire the position thus detected.

The position detection unit 101 may detect the positions of all the RFID tags in the store. Alternatively, the position detection unit 101 may detect the positions of RFID tags in a predetermined region in the store. The position detection unit 101 may also detect the positions of predetermined RFID tags in the store.

The position detection unit 101 may detect the position of an RFID tag at predetermined time intervals. The predetermined time interval is, for example, several seconds or several tens of seconds. The predetermined time interval at which the position detection unit 101 detects the position of an RFID tag is not limited to these examples, and may be appropriately determined according to the size of the store, the number of RFID tags whose positions are to be detected in the store, the number of customers in the store, or the like.

The RFID tags whose positions are detected by the position detection unit 101 are RFID tags attached to products. The RFID tags whose positions are detected by the position detection unit 101 may also be RFID tags attached to articles other than products. An example of the case where the position detection unit 101 detects the positions of RFID tags attached to articles other than products will be described in another application example.

The movement detection unit 102 is an example of a movement detection means for detecting movement of an RFID tag based on the position history of the RFID tag. In a case where the position of any of the RFID tags whose positions are detected by the position detection unit 101 has changed based on the position history of that RFID tag stored in time series, the movement detection unit 102 detects that the RFID tag has moved. The movement detection unit 102 may detect that an RFID tag has moved if the detected position of the RFID tag has changed over a predetermined period of time or more, or a predetermined number of times or more, and by a predetermined distance or more, based on the position history of the RFID tag detected at predetermined time intervals.

The movement detection unit 102 may detect that an RFID tag has been stationary if the position of the RFID tag has not changed based on the position history of that RFID tag stored in time series. The movement detection unit 102 may detect that an RFID tag has been stationary if the detected position of the RFID tag has changed over less than a predetermined period of time or by less than a predetermined distance, based on the position history of the RFID tag detected at predetermined time intervals.

The position histories of the RFID tags may be stored in a storage unit (not illustrated). The movement detection unit 102 detects movement of an RFID tag based on the position history of the RFID tag stored in the storage unit. In addition, for an RFID tag detected not to have moved, the movement detection unit 102 may retain the history for the number of positions required for movement detection and remove the rest. As a result, the amount of data stored in the storage unit (not illustrated) can be reduced. Since an RFID tag detected to have moved is estimated to have begun being carried by the customer, the movement detection unit 102 may store the position history of the RFID tag in the storage unit without removing any part of it. As a result, it is possible to record the history of movement of each RFID tag estimated to have begun being carried by the customer. The history of movement will be described in a second example embodiment.

The management unit 103 is an example of a management means for associating the position history of an RFID tag detected to have moved with the position history of another RFID tag detected to have moved in a similar manner, as a group of movement histories. For example, in a storage unit (not illustrated), the management unit 103 may assign a management number to the position history of an RFID tag detected to have moved as a group of movement histories, and may associate the position history of another RFID tag detected to have moved in a similar manner with the group of movement histories. The management numbers may be character information for identifying groups of movement histories. More than one position history may be associated with a group of movement histories.

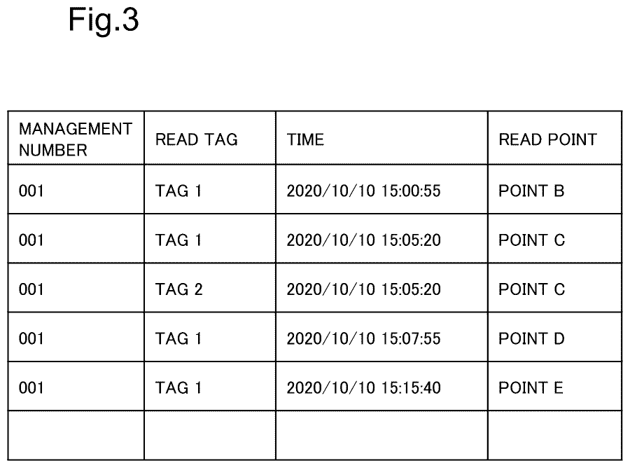

FIG. 3 is a diagram illustrating an example of a group of movement histories managed by the management unit 103. In FIG. 3, the group of movement histories includes a management number, the times at which the positions of each RFID tag were detected, the positions at which each RFID tag was detected (“read point” in FIG. 3), and the identification information of each RFID tag associated at the time when the RFID tag was detected (“read tag” in FIG. 3). In FIG. 3, the tags 1 and 2 are examples of the identification information of RFID tags detected to have moved.

In FIG. 3, the position history of the tag 1 detected to have moved at the point B is recorded in association with a management number 001 as a group of movement histories. In addition, in FIG. 3, in addition to the position history of the tag 1, the position history of the tag 2 detected to have moved in a manner similar to the tag 1 at the point C is associated with the group of movement histories of the management number 001. Furthermore, in FIG. 3, the position history of the tag 1 moving at the points D and E is associated with the group of movement histories of the management number 001. The recording of a group of movement histories is not limited to this example.

Here, a method of detecting similar movements of RFID tags will be described. The management unit 103 detects that RFID tags have moved in a similar manner if their positions are detected within a predetermined distance continuously for a predetermined time or more or a predetermined number of times or more based on the position histories of a plurality of RFID tags detected to have moved by the movement detection unit 102. The condition requiring that the positions of RFID tags to be within a predetermined distance may specifically be that their positions be detected at the same point. Alternatively, the management unit 103 may detect that RFID tags have moved in a similar manner if their positions are detected within a predetermined distance a predetermined number of times or more within a predetermined time based on the position histories of a plurality of RFID tags detected to have moved by the movement detection unit 102. That is, even in a case where there is a slight error in the position of each detected RFID tag, the management unit 103 may detect that the RFID tags have moved in a similar manner if the error is within the range of errors that occur when a customer carries a product. The predetermined time, number of times, and distance may be appropriately determined so that it is possible to determine whether a customer is carrying a product, according to the size of the store, the number of RFID tags whose positions are to be detected in the store, the number of customers in the store, the performance of the antennas that receive signals from the RFID tags, and the like. Thus, the management unit 103 associates the RFID tags detected to have moved in a similar manner as a group of movement histories.

In addition, the management unit 103 may disassociate the position history of an RFID tag that is no longer detected to be moving in a manner similar to the other RFID tags associated with the group of movement histories. As a process of disassociation, the management unit 103 disassociates the position history of the RFID tag detected to no longer be moving in a manner similar to the other RFID tags associated with the group of movement histories, after the time point when they were detected to have stopped moving in a similar manner.

For example, the management unit 103 disassociates the position history of an RFID tag that remains stationary for a predetermined time or more in the group of movement histories. For example, in a case where a customer returns a part of a plurality of products the customer was carrying to a product shelf or the like, the RFID tag attached to the product that the customer no longer carries will not move, and therefore, the management unit 103 disassociates the position history of the RFID tag. The predetermined time during which an RFID tag remains stationary may be appropriately determined, but for example, the predetermined time during which an RFID tag remains stationary may be set to a time longer than the predetermined time used for detecting movement. This is because sometimes a customer stops and hesitates to purchase a product being carried. In addition, the predetermined time during which an RFID tag remains stationary may be set differently depending on the position in the store. For example, in a store that sells clothing products, in front of a mirror, in a fitting room, or the like, where a customer often hesitates to purchase a product, the predetermined time during which an RFID tag remains stationary may be set longer than that at other positions.

As described above, in a case where the management unit 103 disassociates the position history of an RFID tag that has been stationary for a predetermined time or more, the product related to the disassociated RFID tag is a product that the customer picked up but put down. Therefore, in a case where the management unit 103 disassociates the position history of an RFID tag that has been stationary for a predetermined time or more, the movement-history management device 100 can record products that the customer picked up but did not purchase with a simple configuration. In addition, the movement-history management device 100 can record the time for which a product that the customer picked up but did not purchase was carried by the customer and the position at which the customer put down the product, based on the time and position at which the RFID tag was disassociated.

In addition, for example, the management unit 103 disassociates the position history of an RFID tag in the group of movement histories whose position is no longer detected. For example, in a case where a customer hands over a part of a plurality of products being carried to a store clerk or the like and the store clerk moves the one or more products to a backyard or the like outside the antennas' RFID tag reading range, the positions of the RFID tags attached to the products that the customer no longer carries are no longer detected, and thus the management unit 103 disassociates the position histories of the RFID tags.

In addition, for example, the management unit 103 may disassociate the position history of an RFID tag in the group of movement histories whose position has been detected in a predetermined area. Here, the predetermined area is an area where products are collected in a case where customers do not purchase them. In stores selling clothing products, the predetermined area is, for example, a counter in a fitting room. In stores selling clothing products, the customer may request a store clerk to return products not to be purchased at the counter in the fitting room. Therefore, the management unit 103 disassociates the position histories of the RFID tags whose positions have been detected in the area, which is the counter in the fitting room. At this time, the predetermined area may be any place where a customer places products that the customer will not purchase. For example, the predetermined area may be the backyard of a store.

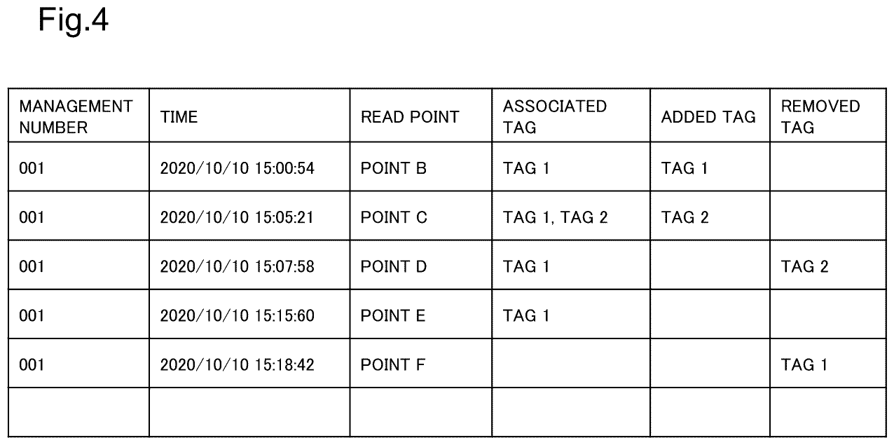

FIG. 4 is a diagram illustrating another example of a group of movement histories managed by the management unit 103. In FIG. 4, the group of movement histories includes a management number, the times when the positions of each RFID tag were detected, the positions where the RFID tags were detected (“read point” in FIG. 4), the identification information of each RFID tag associated at that time (“associated tag” in FIG. 4), the identification information of an RFID tag newly associated at that time (“added tag” in FIG. 4), and the identification information of an RFID tag disassociated at that time (“removed tag” in FIG. 4). In FIG. 4, the tags 1 and 2 are examples of the identification information of RFID tags detected to have moved.

In FIG. 4, the position history of the tag 1 detected to have moved at the point B is recorded in association with a management number 001 as a group of movement histories. In addition, in FIG. 4, in addition to the position history of the tag 1, the position history of the tag 2 detected to have moved in a manner similar to the tag 1 at the point C is associated with the group of movement histories of the management number 001. The tag 2 is recorded in the group of movement histories of the management number 001 as an RFID tag added at this time (added tag). In FIG. 4, the position history of the tag 1 moving at the points D and E is associated with the group of movement histories of the management number 001. In addition, at the point D, the tag 2 is recorded in the group of movement histories of the management number 001 as an RFID tag that is no longer moving in a similar manner and therefore is disassociated at this time point (removed tag). Furthermore, in FIG. 4, the tag 1 is recorded in the group of movement histories of the management number 001 as an RFID tag whose position is no longer detected at the point F at this time point (removed tag). Since all the positions of the RFID tags included in the group of movement histories of the management number 001 are no longer detected at the point F, the management unit 103 terminates the group of movement histories of the management number 001 here. The recording of a group of movement histories is not limited to this example. The management unit 103 also ends the management of a group of movement histories at a predetermined instance. The predetermined instance is the case where all of the RFID tags associated with the group of movement histories have been stationary for a predetermined time or more, the case where their positions are no longer detected, or the case where payment has been made for the products to which the RFID tags associated with the group of movement histories are attached. The end of the management of a group of movement histories means ending a series of processes for the group of movement histories, such as detection of RFID tags that move in a manner similar to the group of movement histories and disassociation of RFID tags that no longer move in a manner similar to the group of movement histories. As processing for ending the management of a group of movement histories, the management unit 103 may further store the group of movement histories in a storage location such as a predetermined storage unit.

In a case where all the RFID tags associated with the group of movement histories have been stationary for a predetermined time or more, or in a case where their positions are no longer detected, it is estimated that the customer has returned all the products the customer was carrying, or has left the store with the products. Therefore, the management unit 103 ends the management of the position histories of the RFID tags associated with the group of movement histories.

Alternatively, in a case where a payment is made for the products to which the RFID tags associated with the group of movement histories are attached, it is estimated that the customer paid for the products the customer was carrying and left the store. Therefore, the management unit 103 ends the management of the position histories of the RFID tags associated with the group of movement histories. At this time, the management unit 103 may acquire information read from the RFID tags used to pay for the products in the payment device, and detect that the products to which the RFID tags are attached have been paid for.

Note that, in a case where the management unit 103 acquires the information read from the RFID tags used to pay for the products related to the group of movement histories in this manner, the movement-history management device 100 can record products that the customer picked up but did not purchase without performing the above-described disassociation process. For example, an RFID tag that is included in the information on the RFID tags associated with the group of movement histories but not included in the information read from the RFID tags used to pay for the products is estimated to be a product that the customer picked up but did not purchase.

The management unit 103 may associate with the group of movement histories the customer's membership information included in the payment information of the products to which the RFID tags associated with the group of movement histories are attached. In that case, the management unit 103 may associate the group of movement histories with the customer's membership information included in the payment information of the products to which the RFID tags associated with the group of movement histories are attached in a membership information database provided outside or inside the movement-history management device. Furthermore, in that case, the management unit 103 may replace the management number assigned to the group of movement histories with the customer's membership information.

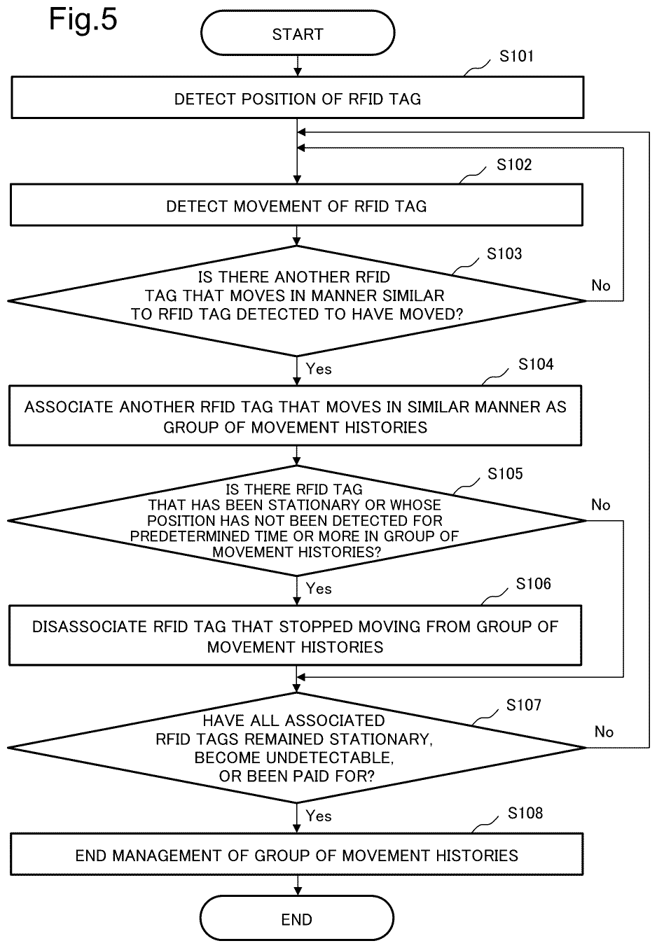

The operation of the movement-history management device 100 configured as described above will be described with reference to the flowchart of FIG. 5.

As illustrated in FIG. 5, first, the position detection unit 101 detects the positions of RFID tags (step S101).

Next, the movement detection unit 102 detects that one or more of the RFID tags have moved based on the positions of the RFID tags detected in step S101 (step S102). At this time, the management unit 103 may start management by assigning a management number to each of the position histories of the RFID tags detected to have moved.

Steps S101 and S102 may be continuously performed at predetermined time intervals.

Next, the management unit 103 detects another RFID tag that moves in a manner similar to an RFID tag detected to have moved among the RFID tags detected to have moved in step S102 (step S103). In a case where another RFID tag moving in a similar manner is not detected (Step S103: No), the management unit 103 returns to the operation of step S102.

In a case where another RFID tag that moves in a similar manner is detected in step S103 (step S103: Yes), the management unit 103 associates the RFID tag that moves in a similar manner as a group of movement histories (step S104). For example, in a case where a management number is assigned to the position history of the RFID tag in step S102, the management number is used as the management number of the group of movement histories in step S104.

The management unit 103 detects whether there is an RFID tag that has been stationary for a predetermined time or more or an RFID tag whose position is no longer detected based on the position histories of the RFID tags associated with the group of movement histories (step S105).

In step S105, if an RFID tag that has been stationary for a predetermined time or more or an RFID tag whose position is no longer detected is detected from the position histories of the RFID tags associated with the group of movement histories (step S105: Yes), the management unit 103 disassociates the position history of that RFID tag (step S106). In step S105, if an RFID tag that has been stationary for a predetermined time or more or an RFID tag whose position is no longer detected is not detected from the position histories of the RFID tags associated with the group of movement histories (step S105: No), the management unit 103 proceeds to the operation of step S107.

The management unit 103 detects whether all the RFID tags associated as the group of movement histories have been stationary for the predetermined time or more, their positions are no longer detected, or payment has been made for them (step S107). In a case where an RFID tag associated as the group of movement histories is moving or has not been paid for (step S107: No), the management unit 103 returns to the operation of step S102.

In a case where the management unit 103 detects in step S107 that all the RFID tags associated as the group of movement histories have been stationary for the predetermined time or more, their positions are no longer detected, or payment has been made for them (step S107; Yes), the management unit 103 ends the management of the group of movement histories (step S108).

The movement-history management device 100 thereby ends the series of operations. The movement-history management device 100 may carry out the operations simultaneously on a plurality of RFID tags and a plurality of groups of movement histories. In addition, the movement-history management device 100 may perform the series of operations in real time or at a later time.

In the movement-history management device 100 according to the present example embodiment described above, the management unit 103 associates the position history of an RFID tag detected to have moved with the position history of another RFID tag detected to have moved in a similar manner as a group of movement histories. Since the movement-history management device 100 according to the present example embodiment associates products that the customer picked up and carried with the group of movement histories, it is possible to recognize the products which the customer was carrying in the store and was therefore interested in or intended to purchase based on the RFID tags associated with the group of movement histories.

As a result, the movement-history management device 100 according to the present example embodiment can manage the movement history with a simple configuration.

In particular, in a store, an RFID tag may be attached as a price label tag to each product used to make a payment for the product. In addition, in a store, one or more antennas for reading the RFID tag attached to products may be provided in order to manage the products. In this case, the movement-history management device 100 according to the present example embodiment can manage the movement history with a simple configuration by using the provided RFID tags and antennas.

In addition, for example, the movement-history management device 100 according to the present example embodiment can manage the movement history even in a case where a customer does not carry a basket to which an RFID tag is added.

### Second Example Embodiment

Next, a second example embodiment of the present disclosure will be described in detail with reference to the drawings. A movement-history management device 200 according to the second example embodiment enables recording of the movement path of a customer carrying a product in a store. Hereinafter, description of contents overlapping with the above description will be omitted to the extent that the description of the present example embodiment is not unclear.

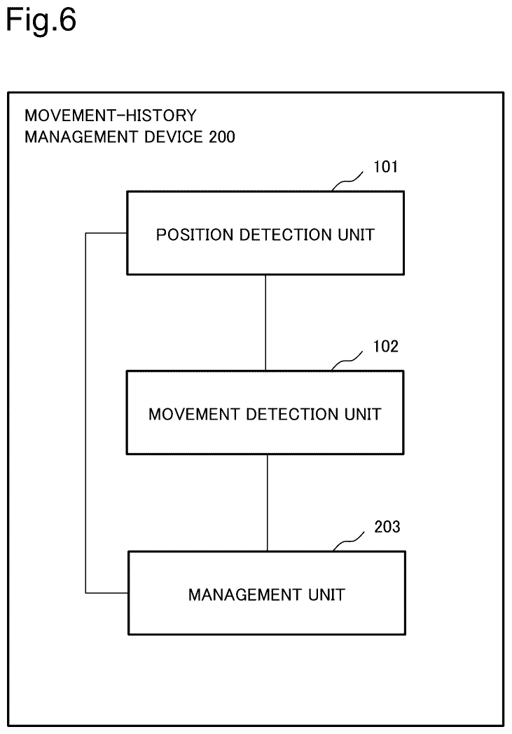

FIG. 6 is a block diagram illustrating a configuration of a movement-history management device according to the second example embodiment of the present disclosure. The movement-history management device 200 of the second example embodiment includes a management unit 203 instead of the management unit 103 of the first example embodiment.

In addition to the functions of the management unit 103, the management unit 203 continuously manages the group of movement histories based on the position histories of RFID tags associated with the group of movement histories. The position histories of RFID tags associated with the group of movement histories and obtained continuously can be estimated to be the movement history of a customer in the store who carries products associated with the group of movement histories.

For example, the management unit 203 may generate the movement path of the customer according to the group of movement histories based on the position histories of RFID tags associated with the continuously detected group of movement histories. £ The movement path of the customer may be indicated by data in which dwell positions and dwell time points in the store are associated with each other, may be drawn by arrows or the like on a map in the store, or may be indicated by the product(s) placed at each position in the movement path, the customer's dwell duration time at each position, and the like. In addition, for an RFID tag detected to no longer be moving in a similar manner in the group of movement histories, the management unit 203 may store, in the storage unit, the position where it was detected to have stopped moving in a similar manner, and the product associated with the RFID tag.

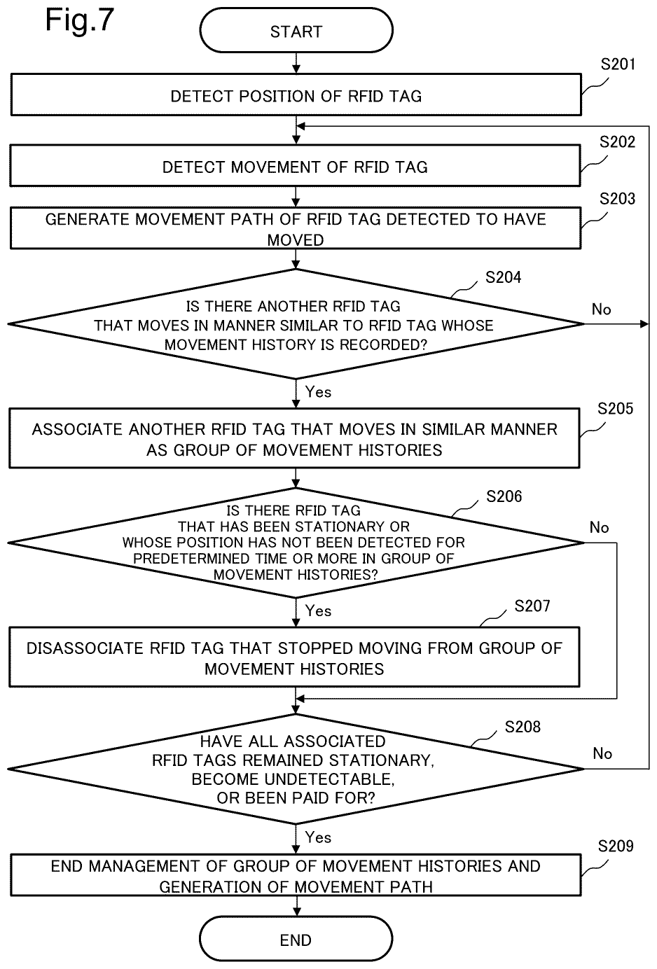

The operation of the movement-history management device 200 configured as described above will be described with reference to the flowchart of FIG. 7.

As illustrated in FIG. 7, the position detection unit 101 detects the positions of RFID tags (step S201).

Next, the movement detection unit 102 detects that one or more of the RFID tags have moved based on the positions of the RFID tags detected in step S201 (step S202). At this time, the management unit 103 may start management by assigning a management number to each of the RFID tags detected to have moved.

Steps S201 and S202 may be continuously performed at predetermined time intervals.

The management unit 203 continuously manages the position histories of the RFID tags detected to have moved in step S202 as a group of movement histories (step S203). For example, the management unit 203 continuously stores the position histories of the RFID tags detected to have moved in step S202 in the storage unit as a group of movement histories.

Next, the management unit 203 detects another RFID tag that moves in a manner similar to an RFID tag detected to have moved among the RFID tags detected to have moved in step S202 (step S204). In a case where another RFID tag moving in a similar manner is not detected (Step S204: No), the management unit 203 returns to the operation of step S202.

In a case where another RFID tag that moves in a similar manner is detected in step S204 (step S204: Yes), the management unit 203 associates the RFID tag that moves in a similar manner as a group of movement histories (step S205). As described in step S203, the management unit 203 continuously manages the position histories of the associated RFID tags as a group of movement histories.

The management unit 203 detects whether there is an RFID tag that has been stationary for a predetermined time or more or an RFID tag whose position is no longer detected based on the position histories of the RFID tags associated with the group of movement histories (step S206).

In step S206, if an RFID tag that has been stationary for a predetermined time or more or an RFID tag whose position is no longer detected is detected from the position histories of the RFID tags associated with the group of movement histories (step S206: Yes), the management unit 203 disassociates the position history of that RFID tag (step S207). In step S206, if an RFID tag that has been stationary for a predetermined time or more or an RFID tag whose position is no longer detected is not detected from the position histories of the RFID tags associated with the group of movement histories (step S206: No), the management unit 203 proceeds to the operation of step S208.

The management unit 203 detects whether all the RFID tags associated as the group of movement histories have been stationary for the predetermined time or more, their positions are no longer detected, or payment has been made for them (step S208). In a case where an RFID tag associated as the group of movement histories is moving or has not been paid for (step S208: No), the management unit 203 returns to the operation of step S202.

In a case where the management unit 203 detects in step S208 that all the RFID tags associated as the group of movement histories have been stationary for the predetermined time or more, their positions are no longer detected, or payment has been made for them (step S208; Yes), the management unit 203 ends the management of the group of movement histories (step S209). For example, in a case where the management unit 203 generates a movement path according to a group of movement histories, the management unit 203 generates a movement path according to a group of movement histories up to when it is detected that all the RFID tags associated as a group of movement histories have been stationary for a predetermined time or more, their positions are no longer detected, or a payment has been made for them.

The movement-history management device 200 thereby ends the series of operations. The movement-history management device 200 may carry out the operations simultaneously on a plurality of RFID tags and a plurality of groups of movement histories. In addition, the movement-history management device 200 may perform the series of operations in real time or at a later time.

In the movement-history management device 200 according to the present example embodiment described above, the management unit 203 associates the position history of an RFID tag detected to have moved with the position history of another RFID tag detected to have moved in a similar manner as a group of movement histories. Since the movement-history management device 200 according to the present example embodiment associates products that the customer picked up and carried with the group of movement histories, it is possible to recognize the products which the customer was carrying in the store and was therefore interested in or intended to purchase based on the RFID tags associated with the group of movement histories.

As a result, the movement-history management device 200 according to the present example embodiment can manage the movement history with a simple configuration.

In addition, in the movement-history management device 200 according to the present example embodiment described above, the management unit 203 continuously manages the group of movement histories based on the position histories of RFID tags associated with the group of movement histories.

As a result, the movement-history management device 200 according to the present example embodiment can enable storing the movement history of customers with a simple configuration. In particular, the movement-history management device 200 according to the present example embodiment can record the movement history of customers with a simple configuration without using customer route detection by video analysis or RFID tags attached to baskets or the like carried by the customers.

### Modified Example

The movement-history management device in each example embodiment may be modified as follows. Note that the following modifications and application examples will be described by taking the movement-history management device 100 in the first example embodiment as an example, but similar changes can be applied to the movement-history management device 200 in the second example embodiment.

If a certain area is included in the position history of an RFID tag associated with a group of movement histories, the management unit 103 may associate information on the behavior of the customer in that area with the group of movement histories.

For example, in a store that handles clothing products, in a case where an area serving as a fitting room is included in the position history of an RFID tag associated with a group of movement histories, the management unit 103 may associate information indicating that the customer tried on clothing with the group of movement histories. For example, in a case where a dwell duration of a predetermined time or more is detected in an area serving as a fitting room based on the position history of the RFID tag associated with a group of movement histories, the management unit 103 may associate information indicating that the customer tried on clothing with the group of movement histories. In this case, in addition to an area serving as a fitting room, if a dwell duration of a predetermined time or more is detected in an area in front of a mirror in the position history of an RFID tag associated with a group of movement histories, the management unit 103 may also associate information indicating that the customer tried on clothing with the group of movement histories.

### Other Application Examples

Processing related to RFID tags attached to products performed by the movement-history management device 100 has been described in each example embodiment. However, the movement-history management device 100 may perform processing using RFID tags attached to articles in the store other than products.

### <Example 1: Case of Using RFID Tags Attached to Articles Carried By Customers>

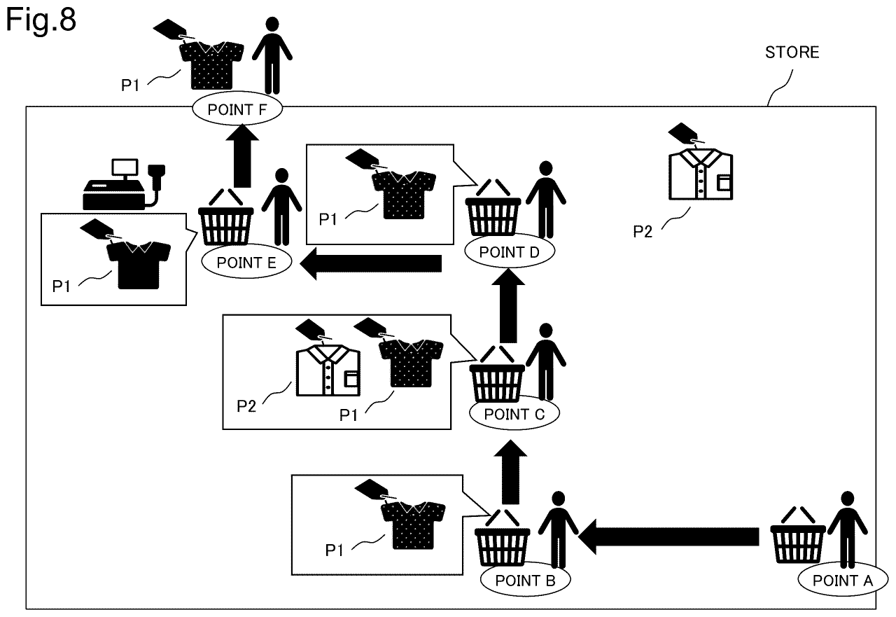

FIG. 8 is a diagram illustrating an application example in the case where RFID tags attached to articles carried by customers are used, which is another application example of the movement-history management device 100 according to the present disclosure. The parts of the application example illustrated in FIG. 8 that differ from the application example illustrated in FIG. 1 will be described.

At the point A in FIG. 8, the customer enters the store. The customer who has entered the store picks up a basket to which an RFID tag is attached. Here, the basket is an example of an article carried by a customer. Examples of the article carried by a customer and to which an RFID tag is attached include, in addition to a basket, a membership card, a wristband, and a coupon sheet that the customer has taken out from the customer's bag, wallet, or the like. The RFID tag attached to the article carried by the customer may contain information indicating that the article is not a product but an article carried by the customer. For example, the RFID tag attached to the basket may contain information indicating that it is a basket.

Since the customer carries the RFID tag, the position detection unit 101 can detect the position of the RFID tag attached to the basket. Then, the movement detection unit 102 can detect movement of the RFID tag attached to the basket based on the position history of the RFID tag attached to the basket. Therefore, the management unit 103 of the movement-history management device 100 can manage the movement history of the customer before the customer picks up a product. For example, in the example of FIG. 8, the management unit 103 of the movement-history management device 100 can manage the customer's movement history from the point A to point B. In that case, the management unit 103 in the movement-history management device 100 may set the RFID tag detected to have moved as a group of movement histories, and associate it with RFID tags detected to have moved in a similar manner.

Furthermore, in a case where an RFID tag attached to an article carried by a customer is used, instead of the management number described in the first example embodiment, the group of movement histories may be managed using information read from the RFID tag attached to the article carried by the customer.

### <Example 2: Case of Using RFID Tags Attached to Articles Carried by Employees>

In each movement-history management device 100, the position detection unit 101 may detect the positions of RFID tags attached to articles carried by employees based on signals received from the RFID tags. Examples of the articles carried by the employees to which RFID tags are attached include the employees' name tags, uniforms, and ID cards, and terminal devices used by the employees. The RFID tag attached to an article carried by an employee may include information indicating that the article is not a product or an article carried by a customer but an article carried by an employee. For example, the RFID tag attached to an employee's ID card may include information indicating that it is an employee's ID card.

In that case, the management unit 103 may not perform the series of operations described in the example embodiments on RFID tags attached to products or articles that move in a manner similar to RFID tags attached to articles carried by employees. As a result, the movement-history management device 100 can exclude the movements of articles such as products or baskets caused by employees in a store and record actions such as customers carrying or moving products in the store.

In another example, the management unit 103 may also perform the processing described in an example embodiment on RFID tags attached to articles carried by employees. In that case, the management unit may manage a group of movement histories associated with RFID tags attached to articles carried by employees separately from another group of movement histories. As a result, the movement-history management device 100 can manage the positions of products or articles moved by employees in a store.

### Second Modification

The management unit 103 of the movement-history management device in each example embodiment and modification may associate a group of movement histories with another group of movement histories. That is, a plurality of associated groups of movement histories may be managed as a group of movement histories. For example, in a case where a group of customers uses a store, the customers may act separately. For example, the management unit 103 may associate groups of movement histories detected to have moved in the same manner. As another example, the management unit 103 may associate separate groups of movement histories for which payment has been made together.

### Hardware Configuration

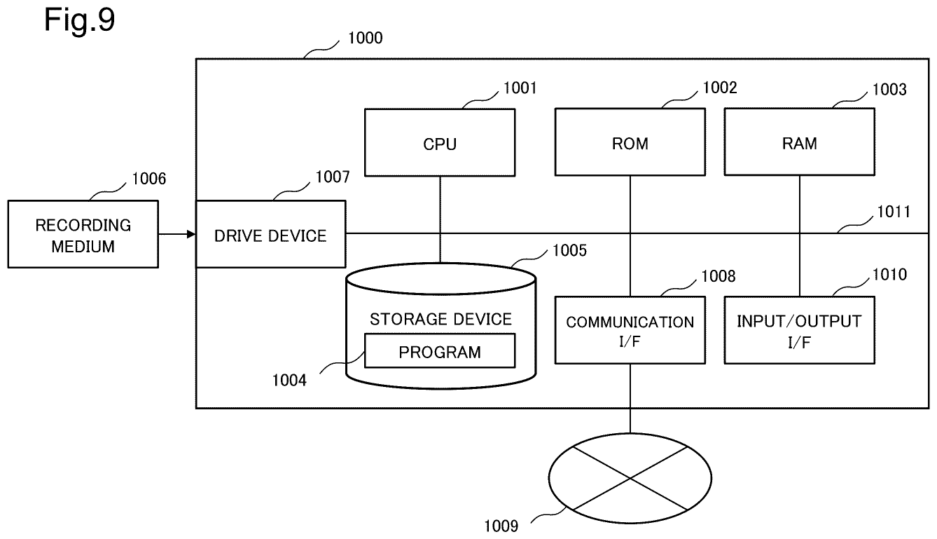

Some or all of the components of each device or system in each example embodiment of the present disclosure described above are achieved by, for example, any combination of an information processing apparatus 1000 and a program as illustrated in FIG. 9. As an example, the information processing apparatus 1000 includes the following components.
A central processing unit (CPU) 1001
A read only memory (ROM) 1002
A random access memory (RAM) 1003
A program 1004 loaded into the RAM 1003
A storage device 1005 storing the program 1004
A drive device 1007 for reading a recording medium 1006
A communication I/F 1008 connected to a communication network 1009
An input/output I/F 1010 for inputting/outputting data
A bus 1011 connecting each component
I/F is an abbreviation of Interface.

Each component of each apparatus or system in each example embodiment is achieved by the CPU 1001 acquiring and executing a program for achieving these functions. The program for achieving the function of each component of each apparatus is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the implementation method of each device. For example, each apparatus or system may be achieved by any combination of the information processing apparatus 1000 and the program separate for each component. A plurality of components included in each apparatus may be achieved by any combination of one information processing apparatus 1000 and the program.

Some or all of the components of each apparatus or system are achieved by a general-purpose or dedicated circuitry including a processor or the like, or a combination thereof. The circuitry is, for example, a CPU, a graphics processing unit (GPU), a field programmable gate array (FPGA), or a large scale integration (LSI) for artificial Intelligence (AI) processing. These may be configured by a single chip or may be configured by a plurality of chips connected via a bus. Some or all of the components of each apparatus may be achieved by a combination of the above-described circuitry and the like and the program.

In a case where some or all of the components of each apparatus or system are achieved by a plurality of the information processing apparatuses, circuits, and the like, the plurality of information processing apparatuses, circuits, and the like may be arranged in a centralized manner or in a distributed manner. For example, each of the information processing apparatuses, circuitry, or the like may be implemented in the form of a client server system, a cloud computing system, or the like in which they are connected to each other through a communication network.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

Although a plurality of operations is described in order in the form of a flowchart, the order of description does not limit the order of executing the plurality of operations. Therefore, when each example embodiment is implemented, the order of the plurality of operations may be changed within a range that does not interfere with the content.

Some or all of the above example embodiments may be described as the following Supplementary Notes, but are not limited to the following.

### [Supplementary Note 1]

A movement-history management device including:
a position detection means for detecting a position of a radio frequency identification (RFID) tag based on a signal received from the RFID tag;
a movement detection means for detecting movement of the RFID tag based on a position history of the RFID tag; and
a management means for associating the position history of the RFID tag detected to have moved with a position history of another RFID tag detected to have moved in a manner similar to the RFID tag detected to have moved, as a group of movement histories.

### [Supplementary Note 2]

The movement-history management device according to Supplementary Note 1, wherein
the management means continuously manages the group of movement histories based on the position histories of the RFID tags associated with the group of movement histories.

### [Supplementary Note 3]

The movement-history management device according to Supplementary Note 2, wherein
the management means disassociates, among the position histories of the RFID tags included in the group of movement histories, a position history of an RFID tag that is no longer detected to move in a manner similar to the another RFID tag.

### [Supplementary Note 4]

The movement-history management device according to Supplementary Note 2 or 3, wherein
the management means disassociates, among the position histories of the RFID tags included in the group of movement histories, a position history of an RFID tag that has been stationary for a predetermined time or more.

### [Supplementary Note 5]

The movement-history management device according to any one of Supplementary Notes 2 to 4, wherein
the management means disassociates, among the position histories of the RFID tags included in the group of movement histories, a position history of an RFID tag whose position is no longer detected.

### [Supplementary Note 6]

The movement-history management device according to any one of Supplementary Notes 2 to 5, wherein
the management means disassociates, among the position histories of the RFID tags included in the group of movement histories, a position history of an RFID tag whose position has been detected in a predetermined area.

### [Supplementary Note 7]

The movement-history management device according to any one of Supplementary Notes 1 to 6, wherein
the management means ends the management of the group of movement histories if all the RFID tags whose position histories are associated with the group of movement histories have been stationary for a predetermined time or more, or if the positions of all the RFID tags whose position histories are associated with the group of movement histories are no longer detected.

### [Supplementary Note 8]

The movement-history management device according to any one of Supplementary Notes 1 to 7, wherein
the management means associates, as a group of movement histories, a position history of the RFID tag detected to have moved with a position history of another RFID tag whose position has been detected at a same point as the position history of the RFID tag detected to have moved, continuously for a predetermined number of times or more.

### [Supplementary Note 9]

The movement-history management device according to any one of Supplementary Notes 1 to 8, wherein
the management means ends the management of the group of movement histories if a payment is made for a product to which an RFID tag associated with the group of movement histories is attached.

### [Supplementary Note 10]

The movement-history management device according to Supplementary Note 9, wherein
the management means associates, with the group of movement histories, membership information of a customer included in payment information of a product to which an RFID tag whose position history is associated with the group of movement histories.

### [Supplementary Note 11]

A movement-history management method including:
detecting, by a computer, a position of an RFID tag based on a signal received from the RFID tag;
detecting, by a computer, movement of the RFID tag based on a position history of the RFID tag; and
associating, by a computer, the position history of the RFID tag detected to have moved with a position history of another RFID tag detected to have moved in a manner similar to the RFID tag detected to have moved, as a group of movement histories.

### [Supplementary Note 12]

A recording medium that records a movement-history management program for causing a computer to execute processing, the processing including:
detecting a position of an RFID tag based on a signal received from the RFID tag;
detecting movement of the RFID tag based on a position history of the RFID tag; and
associating the position history of the RFID tag detected to have moved with a position history of another RFID tag detected to have moved in a manner similar to the RFID tag detected to have moved, as a group of movement histories.

### REFERENCE SIGNS LIST

P1, P2 product
100, 200 movement-history management device
101 position detection unit
102 movement detection unit
103, 203 management unit
200 movement-history management device
1000 information processing apparatus
1001 CPU
1002 ROM
1003 RAM
1004 program
1005 storage device
1006 recording medium
1007 drive device
1008 communication I/F
1009 communication network
1010 input/output I/F
1011 bus

What is claimed is:

1. A movement-history management device comprising:
one or more memories storing instructions; and
one or more processors configured to execute the instructions to:
detect a position of a radio frequency identification (RFID) tag based on a signal received from the RFID tag;
detect movement of the RFID tag based on a position history of the RFID tag; and
associate the position history of the RFID tag detected to have moved with a position history of another RFID tag detected to have moved in a manner similar to the RFID tag detected to have moved, as a group of movement histories.

2. The movement-history management device according to claim 1, wherein the one or more processors are configured to execute the instructions to:
continuously manage the group of movement histories based on the position histories of the RFID tags associated with the group of movement histories.

3. The movement-history management device according to claim 2, wherein the one or more processors are configured to execute the instructions to:
disassociate, among the position histories of the RFID tags included in the group of movement histories, a position history of an RFID tag that is no longer detected to move in a manner similar to another RFID tag.

4. The movement-history management device according to claim 2, wherein the one or more processors are configured to execute the instructions to:
disassociate, among the position histories of the RFID tags included in the group of movement histories, a position history of an RFID tag that has been stationary for a predetermined time or more.

5. The movement-history management device according to claim 2, wherein the one or more processors are configured to execute the instructions to:
disassociate, among the position histories of the RFID tags included in the group of movement histories, a position history of an RFID tag whose position is no longer detected.

6. The movement-history management device according to claim 2, wherein the one or more processors are configured to execute the instructions to:
disassociate, among the position histories of the RFID tags included in the group of movement histories, a position history of an RFID tag whose position has been detected in a predetermined area.

7. The movement-history management device according to claim 1, wherein the one or more processors are configured to execute the instructions to:
end the management of the group of movement histories in a case where all the RFID tags whose position histories are associated with the group of movement histories have been stationary for a predetermined time or more, or in a case where the positions of all the RFID tags whose position histories are associated with the group of movement histories are no longer detected.

8. The movement-history management device according to claim 1, wherein the one or more processors are configured to execute the instructions to:
associate, as a group of movement histories, a position history of the RFID tag detected to have moved with a position history of another RFID tag whose position has been detected at a same point as the position history of the RFID tag detected to have moved, continuously for a predetermined number of times or more.

9. The movement-history management device according to claim 1, wherein the one or more processors are configured to execute the instructions to:
end the management of the group of movement histories in a case where a payment is made for a product to which an RFID tag associated with the group of movement histories is attached.

10. The movement-history management device according to claim 9, wherein the one or more processors are configured to execute the instructions to:
associate, with the group of movement histories, membership information of a customer included in payment information of a product to which an RFID tag whose position history is associated with the group of movement histories.

11. A movement-history management method comprising:
detecting, by a computer, a position of an RFID tag based on a signal received from the RFID tag;
detecting, by a computer, movement of the RFID tag based on a position history of the RFID tag; and
associating, by a computer, the position history of the RFID tag detected to have moved with a position history of another RFID tag detected to have moved in a manner similar to the RFID tag detected to have moved, as a group of movement histories.

12. A non-transitory recording medium that records a movement-history management program for causing a computer to execute processing, the processing comprising:
detecting a position of an RFID tag based on a signal received from the RFID tag;
detecting movement of the RFID tag based on a position history of the RFID tag; and
associating the position history of the RFID tag detected to have moved with a position history of another RFID tag detected to have moved in a manner similar to the RFID tag detected to have moved, as a group of movement histories.
